(19) United States
(12) Patent Application Publication
(10) Pub. No.: US 2025/0061496 A1
(43) Pub. Date: Feb. 20, 2025

(54) SYSTEMS AND METHODS FOR ANALYZING CUSTOMER COMPLAINTS

(71) Applicant: The PNC Financial Services Group, Inc., Pittsburgh, PA (US)

(72) Inventors: William Robert CHRISTE, JR., Erie, PA (US); David Michael FINK, Wickliffe, OH (US); Mark Gregory MEADEN, Hinckley, OH (US); Chaitanya VEJENDLA, Lewis Center, OH (US); Ashley Nicole ANHALT, McKees Rocks, PA (US); David Michael BROWN, Freeport, PA (US)

(73) Assignee: The PNC Financial Services Group, Inc., Pittsburgh, PA (US)

(21) Appl. No.: 18/939,204

(22) Filed: Nov. 6, 2024

Related U.S. Application Data
(63) Continuation of application No. 18/622,302, filed on Mar. 29, 2024.
Application No. 18/622,302 is a continuation of application No. 18/356,734, filed on Jul. 21, 2023, now abandoned.
(60) Provisional application No. 63/436,317, filed on Dec. 30, 2022.

(51) Int. Cl. G06Q 30/0282

(52) U.S. Cl. CPC G06Q 30/0282

(57) ABSTRACT

A computer-implemented method for obtaining data for reporting and analysis includes integrating data from a plurality of data sources; processing the integrated data using natural language processing; scoring the processed data based on a plurality of score categories; categorizing the processed data into a plurality of categories based on the score and the score category; and outputting the score and the categorized data for reporting and analysis.

### RELATED APPLICATIONS

This application claims priority from U.S. Provisional Patent Application No. 63/436,317, filed on Dec. 30, 2022, the entire disclosure of which is incorporated by reference in the present application.

### TECHNICAL FIELD

The present disclosure relates generally to systems and methods for obtaining data for reporting and analysis. More specifically, and without limitation, this disclosure relates to aggregating customer complaint data from a plurality of sources; extracting, processing, and scoring desired data from the aggregated customer complaint data; and categorizing and outputting the scored data for reporting and analysis.

### BACKGROUND

In some business environments (e.g., a financial institution or a bank), customer complaints may need to be logged and retained to meet industry or governmental reporting requirements. For example, it may be necessary to adhere to regulatory requirements of the Consumer Complaint Program based on the Office of the Comptroller of Currency (OCC) and Consumer Financial Protection Bureau (CFPB) Compliance Management System (CMS) guidelines.

The reporting requirements for different regulatory authorities may not overlap and may require different elements. It may therefore be useful to digitize the customer complaints, regardless of the source of the customer complaint, whether an electronic message or a voice message. Additionally, it may be beneficial to electronically process the customer complaints and to perform analytics on the customer complaints to assist with the various reporting requirements. The electronic processing, analysis, and reporting enables a centralized environment for consistent reporting, minimizing user error risk, and driving efficiency across different regulatory authority reporting requirements, all derived from the same data sources.

Some existing solutions require substantial data movement between different components and require manual intervention at certain points in the process, potentially slowing the overall process.

The inventors have identified a need to overcome these and other drawbacks of existing systems and for improved systems and methods for developing digital experience applications.

### SUMMARY

In view of the foregoing, embodiments of the present disclosure provide computer-implemented systems and methods for aggregating data from a plurality of sources; extracting, processing, and scoring desired data from the aggregated data; and categorizing and outputting the scored data for reporting and analysis.

In one aspect, a computer-implemented method for obtaining data for reporting and analysis includes gathering data from a plurality of data sources; extracting desired data from the gathered data using an extraction, transformation, and loading process; processing the extracted data using natural language processing; scoring the processed data based on a plurality of score categories; categorizing the processed data into a plurality of categories based on the score and the score category; and outputting the score and the categorized data for reporting and analysis.

In another aspect, a computer-implemented reporting and analysis application includes a data aggregation component, a data extraction component, a natural language processing component, a scoring component, a categorizing component, and a reporting and analysis component. The data aggregation component is configured to aggregate a plurality of data sources. The data extraction component is configured to extract desired data from the aggregated data using an extraction, transformation, and loading process. The natural language processing component is configured to process the extracted data using natural language processing. The scoring component is configured to score the processed data based on a plurality of score categories. The categorizing component is configured to categorize the processed data into a plurality of categories based on the score and the score category. The reporting and analysis component is configured to analyze the score and the categorized data.

In another aspect, a computer-implemented root cause analysis application includes one or more databases including scored and categorized data, wherein the data is categorized into a plurality of score categories; an ingestion component; and a user interface. The ingestion component is configured to ingest the scored and categorized data from the one or more databases and prepare the scored and categorized data for display in the user interface. The user interface is configured to permit a user to interact with the displayed data, including any one or more of: viewing the displayed data, updating the displayed data, or resolving an issue presented in the displayed data.

In another aspect, a computer-implemented natural language processing application includes a data extraction component, a scoring component, and a statistics component. The data extraction component is configured to extract desired data from a plurality of data sources, wherein the plurality of sources includes audio data or text data. The scoring component is configured to score the extracted data based on keywords present in the extracted data. The statistics component is configured to generate statistics based on the extracted data.

In another aspect, a computer-implemented data scoring application includes a data extraction component and a scoring component. The data extraction component is configured to extract desired data from a plurality of data sources, wherein the plurality of sources includes audio data or text data. The scoring component is configured to score the extracted data based on a plurality of score categories and keywords present in the extracted data and place the extracted data into a category based on the score of the extracted data.

It is to be understood that the foregoing general description and the following detailed description are exemplary and explanatory only, and are not restrictive of the disclosed embodiments.

### BRIEF DESCRIPTION OF DRAWINGS

The accompanying drawings, which comprise a part of this specification, illustrate several embodiments and, together with the description, serve to explain the principles and features of the disclosed embodiments. In the drawings:

FIG. 1 is a diagram of a working environment for processing customer complaints, consistent with disclosed embodiments.

FIG. 2 is a diagram of a first exemplary system for performing customer complaint analytics, consistent with disclosed embodiments.

FIG. 3 is a diagram of a second exemplary system for performing customer complaint analytics, consistent with disclosed embodiments.

FIG. 4 is a diagram of a third exemplary system for performing customer complaint analytics, consistent with disclosed embodiments.

FIG. 5 is a flowchart of an exemplary method for performing customer complaint analytics, consistent with disclosed embodiments.

FIG. 6 is a diagram of a fourth exemplary system for performing customer complaint analytics, consistent with disclosed embodiments.

### DETAILED DESCRIPTION

Reference will now be made in detail to exemplary embodiments, discussed with regards to the accompanying drawings. In some instances, the same reference numbers will be used throughout the drawings and the following description to refer to the same or like parts. Unless otherwise defined, technical and/or scientific terms have the meaning commonly understood by one of ordinary skill in the art. The disclosed embodiments are described in sufficient detail to enable those skilled in the art to practice the disclosed embodiments. It is to be understood that other embodiments may be utilized and that changes may be made without departing from the scope of the disclosed embodiments. For example, unless otherwise indicated, method steps disclosed in the figures can be rearranged, combined, or divided without departing from the envisioned embodiments. Similarly, additional steps may be added or steps may be removed without departing from the envisioned embodiments. Thus, the materials, methods, and examples are illustrative only and are not intended to be limiting.

Disclosed embodiments provide systems and methods for performing customer complaint analytics.

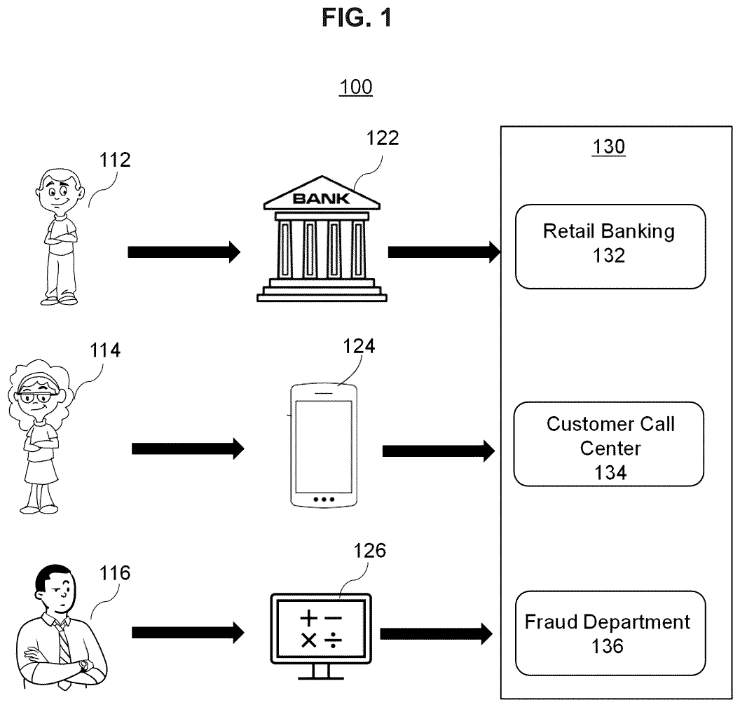

FIG. 1 is a diagram of a working environment 100 for processing customer complaints, consistent with disclosed embodiments. For example, the working environment 100 may be for a financial institution 130, e.g., a bank or a credit card company. Financial institution 130 includes various departments or units that handle different businesses and receive complaints from different customers.

For example, as shown in FIG. 1, a customer 112 may visit the financial institution's physical branch 122 and submits a complaint to a branch clerk, who manually enters the complaint into the financial institution's retail banking system 132. The entered complaint may be in the form of text or an audio/video recording of customer 112. Moreover, a customer 114 may call the financial institution's customer call center 134 to record a complaint via a phone 124. Additionally, customer 116 may submit a complaint by using computer 126 to access a secure portal provided by the financial institution's fraud department 136.

Often, the complaints are stored in fragmented databases owned by different departments and units, e.g., retail banking system 132, customer call center 134, fraud department 136, etc. Thus, financial institution 130 cannot efficiently use the stored data to improve business operation and customer satisfaction. Moreover, the discrete nature of the data also makes it difficult for financial institution 130 to meet the various industry or governmental requirements for reporting the customer complaints. To overcome these problems, the disclosed embodiments are provided to streamline the integrating, processing, analyzing, evaluating, and reporting of the customer complaint data.

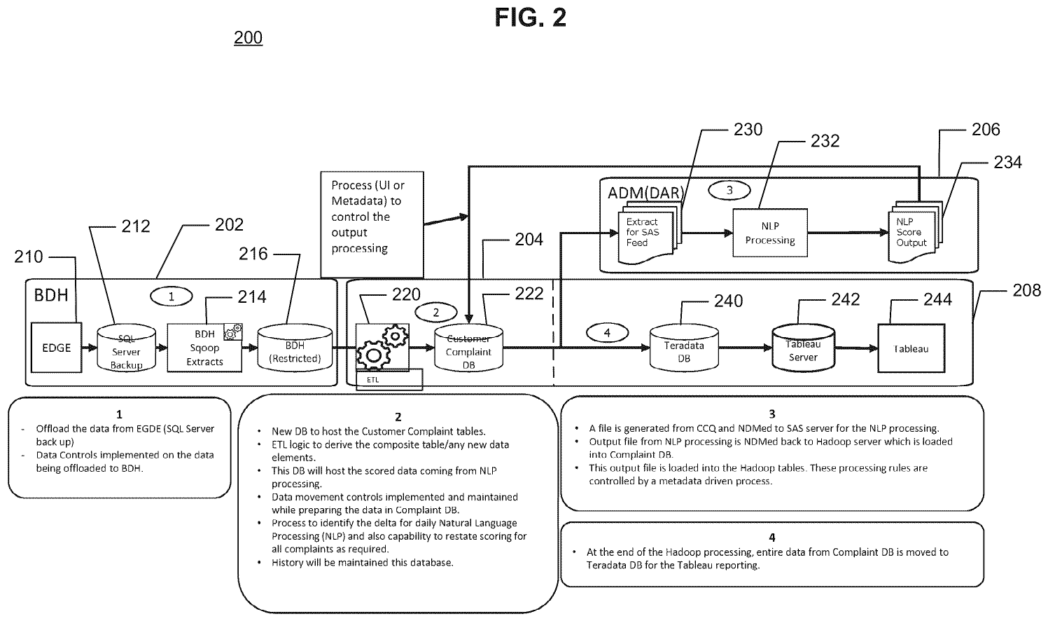

FIG. 2 is a diagram of a first exemplary system 200 for performing customer complaint analytics. System 200 includes a data warehouse 202, an extracting section 204, a processing and scoring section 206, and a reporting and analysis section 208.

The data warehouse 202 includes a backup storage 210, a backup database 212, a transfer component 214, and a relational database 216. In some embodiments, the backup storage 210 is a cloud-based storage. In some embodiments, the backup database 212 is an on-premises storage. In some embodiments, the relational database 216 is a data lake. A “data lake” is a centralized data storage that can store structured data (e.g., data arranged in a row-column format), semi-structured data (a comma-separated values file, a log file, an extensible markup language format, or a JavaScript Object Notation (JSON) format), unstructured data (e.g., emails or documents), or binary data (e.g., images, audio, or video) at any scale. For example, the data lake may store the data as-is, without having to first structure the data. In some embodiments, it may be possible to run different types of analytic processes (e.g., reporting, visualization, and machine learning) on the data in the data lake.

The transfer component 214 is configured to transfer data from the backup database 212 to the relational database 216. In some embodiments, the transfer component 214 may include Apache® Sqoop™. Data controls may be implemented on the data being transferred to the relational database 216. In some embodiments, the data may be modified (e.g., formatted or reformatted) before being transferred into the relational database 216.

The extracting section 204 includes an extraction, transformation, and loading (ETL) component 220 and a customer complaint database 222. The ETL component 220 extracts customer complaint data from the relational database 216, performs any necessary transformations on the extracted customer complaint data, and stores the data in the customer complaint database 222. In some embodiments, the ETL component 220 performs data cleansing (e.g., detecting, correcting, and/or removing corrupt or inaccurate data), data standardization (e.g., converting the data to a standard format), and data derivations (e.g., creating new data by combining and processing existing raw data). For example, the ETL component 220 may be configured to transform the data into prepared analytical data sets (e.g., a portion of the data converted into a particular format) for future reporting and modeling purposes. For example, the data may by transformed into row-compliant data (e.g., data formatted in a particular row-based format). In some embodiments, the data may be matched with customer data before being transferred to the customer complaint database 222. Data movement controls (e.g., controls or permissions that may be associated with moving data from one location to another) may be implemented and maintained while preparing the data in the customer complaint database 222.

The extraction, transformation, and loading (ETL) process performed by the ETL component 220 combines data from multiple sources into a single, consistent data store that may be loaded into a target data storage, e.g., the customer complaint database 222. In the extraction step, data may be copied or exported from one or more source locations to a staging area. In the transformation step, the combined data may be transformed and consolidated for its intended use case. The transformation step may include filtering, cleaning, de-duplicating, validating, authenticating, performing calculations, or formatting the data to match the schema of the target data storage. In the loading step, the transformed data is moved from the staging area to the target data storage, e.g., the customer complaint database 222.

There is a process to identify the delta (i.e., newly received or updated data that has not yet been processed) for daily natural language processing (NLP) on the customer complaint data. In some embodiments, the data is processed into the customer complaint database 222 once a day and therefore, the NLP is performed once a day. In other embodiments, the NLP may be performed more frequently, for example, once an hour or once every few hours on new incoming data.

The processing and scoring section 206 includes an extraction component 230, a natural language processing (NLP) component 232, and an NLP score output component 234. The extraction component 230 extracts data from the customer complaint data for processing by the NLP component 232. The NLP component 232 may use any method for text processing, speech processing, morphological analysis, or syntactical analysis, including using neural networks or other machine learning techniques. The NLP component 232 may also generate a score for each customer complaint that is analyzed and provide the score to the NLP score output component 234.

The scoring may be performed based on a predetermined number of categories, where the categories are used to separate the customer complaints for later analysis. For example, each customer complaint may be scored in each of the categories and some scores may be zero (i.e., that the complaint does not relate to the particular category) and some scores may be non-zero (i.e., that the complaint has some relevance to the category, with a higher score indicating a higher relevance to the category). In some embodiments, all the scores for a customer complaint may be stored, including the categories which receive a zero score. As an example, the scores may be stored as a one-dimensional vector including the zero elements. As another example, the scores may be stored for each category as a “yes/no” value to indicate whether the customer complaint is relevant to the particular category or not. In some embodiments, only the non-zero scores may be stored and include an identifier of each category. As an example, the scores may be stored as a two-dimensional vector including a category identifier and the associated score.

The NLP score output component 234 may perform additional analysis of the score generated by the NLP component 232, such as normalizing or scaling the score, and may store the score in the customer complaint database 222 to be associated with the customer complaint that the score is based on.

In some embodiments, there is a process to restate the scoring for all customer complaints in the customer complaint database 222 as needed. For example, all the data (e.g., all customer complaint data) may be sent to the NLP component 232 for scoring. The scoring may be based on category rules, which in some embodiments, may be manually created or updated. For example, the rules may change and if the rules change, then all the complaint data will need to be rescored to comply with the current rules. For example, the rules may be refined to identify new trends in the data (e.g., a COVID-19 related rule). As another example, new information (e.g., new complaints) may be added to the data, and therefore, the complaints may be rescored every day. In some embodiments, the rescoring process may be based on a trigger. For example, the trigger may include an existing rule being changed, a new rule being added, or an existing complaint being edited.

The reporting and analysis section 208 includes an analytics database 240, a reporting server 242, and a reporting component 244. After the NLP scores have been saved to the customer complaint database 222, the contents of the customer complaint database 222 may be transferred to the analytics database 240. For example, the contents may be transferred on a periodic (e.g., daily) basis. The analytics database 240 is primarily used as an intermediate transfer point for sending the scored customer complaint data to the reporting server 242. The reporting component 244 retrieves the scored customer complaint data from the reporting server 242 and generates various reports to be displayed to a user.

The reports generated by the reporting component 244 may be used to help satisfy governmental and regulatory compliance with respect to the customer complaint data. The reports may include numerical components, textual components, and graphical components. In some embodiments, the textual components and graphical components may be generated using machine learning techniques. In some embodiments, the reports may be interactive such that a user may use the report to “drill down” to different levels of detail based on the displayed report contents. For example, different reports may be created depending on the end-user of the reports, with different end-users being able to receive different reports based on their business needs. In some embodiments, the reports may include one or more interactive components.

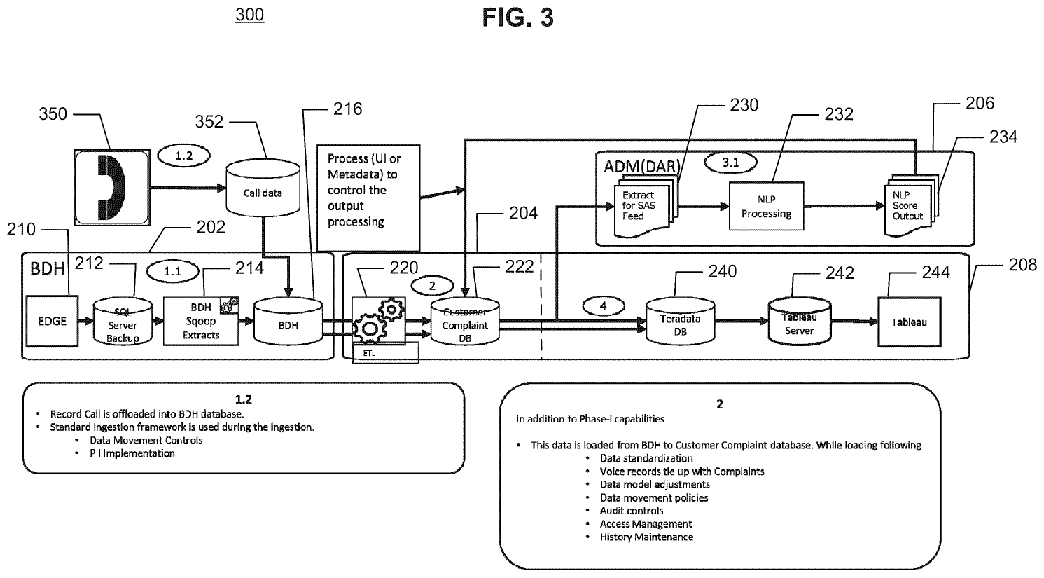

FIG. 3 is a diagram of a second exemplary system 300 for performing customer complaint analytics. Elements of system 300 that are the same as elements of system 200 have been given the same reference numerals and operate in a similar manner as described above in connection with FIG. 2.

In system 300, a customer may provide an audio complaint 350 via telephone. The audio complaint 350 is stored in a call database 352. In some embodiments, the audio complaint 350 may be stored in the call database 352 as an audio file for later processing. In some embodiments, the audio complaint 350 may be transcribed by speech-to-text processing and a text version of the contents of the audio complaint 350 is stored in the call database 352. The speech-to-text processing may be performed by any known method, including using an n-gram model, a Hidden Markov Model, a recurrent neural network, or other machine learning method. In some embodiments, the transcribed complaint is linked to customer complaint data via a logical mapping. For example, the transcribed complaint may include a customer identifier that is mapped to a corresponding customer identifier (e.g., an account number or other unique customer identifier) associated with the customer complaint.

The audio complaint 350, whether in audio form or text form, is provided from call database 352 to the relational database 216. Once the audio complaint 350 is added to the relational database 216, the audio complaint 350 is processed in a similar manner as any other complaint in the relational database 216. Similar ingestion controls are applied to audio complaint 350 as with any of type of complaint, including data movement controls and personally identifiable information (PII) controls. In some embodiments, when the data is in the data lake (e.g., relational database 216), the data is tokenized prior to being transferred to the customer complaint database 222. The process of data tokenization may include replacing one or more sensitive or private data elements (e.g., a customer account number) with a non-sensitive equivalent, referred to as a token. The token may be formatted in a similar manner as the private data element, but the token itself has no particular meaning or value. The token may be used a reference that maps back to the private data through a tokenization system. Any additional processing may be performed on the tokenized data as-is (i.e., the data does not need to be detokenized (converted back to the private data) to perform the processing). As an example, when the data includes fielded and structured data, that data is tokenized and is processed as tokenized data. As another example, unstructured data is not tokenized and is processed in its “plain” form.

In some embodiments, if the audio complaint 350 relates to an existing customer complaint in the relational database 216, the audio complaint 350 is associated with the existing customer complaint. The audio complaint 350 may be associated with the existing customer complaint by any known methods, including storing the audio complaint 350 with the existing customer complaint or by assigning a same record identifier to the audio complaint 350 as has been previously assigned to the existing customer complaint.

The NLP processing component 232 may be configured to perform natural language processing on the audio complaint 350, either in audio form or in text form (e.g., on the transcript of the audio complaint). The NLP score output component 234 may be configured to capture statistical references based on the results of the NLP processing component 232. For example, statistical processes may be performed on the results of the NLP processing component 232 such as a number of complaints processed, a number of complaints in each of a predetermined number of categories, and the like.

When looking for a match between a customer complaint and a received call (e.g., audio complaint 350), calls that have start times within one day (either within one day before or one day after) of the customer complaint's creation date are considered. From there, an attempt is made to match the agent that created the customer complaint with the agent that took the call, as well as the customer the complaint is associated to and the customer that made the call. It may not be possible to match on both of these conditions, so in the cases where the agent and the customer matches could not be identified, agent-only or customer-only matches may be used.

When both an agent match and a customer match are found, this is the strongest and most reliable match type. If multiple agent and customer matches are identified for a particular customer complaint, then the match with a call's end time closest to the creation date of the customer complaint may be chosen as the primary match, and the second closest call end time may be chosen as the secondary match. Any other (tertiary, quaternary, etc.) matches may be disregarded. If only one match is found, the secondary match may be left as NULL. If a customer complaint is matched under this match type, no other match types are considered.

An agent-only match indicates that a match was found between the agent who created the customer complaint and the agent who took the call. If multiple agent-only matches are identified for a particular complaint, then the match with the call end time closest to the creation date of the customer complaint may be chosen as the primary match. Customer-only matches may be considered as the secondary match type in this case, and if there are no customer-only matches, then the secondary match may be left as NULL.

A customer-only match indicates that a match was found between the customer complaint identifier and the call identifier. Complaints not matched by either of the above two match types attempt to match on customer-only as a primary match type. If multiple customer-only matches are identified for a particular complaint, then the match with a call end time closest to the creation date of the customer complaint may be chosen as the primary match. The other matches may be disregarded, and the secondary match may be left as NULL. For example, the matching rules described herein may be used to match a customer complaint with an audio call that the customer complaint most likely came from.

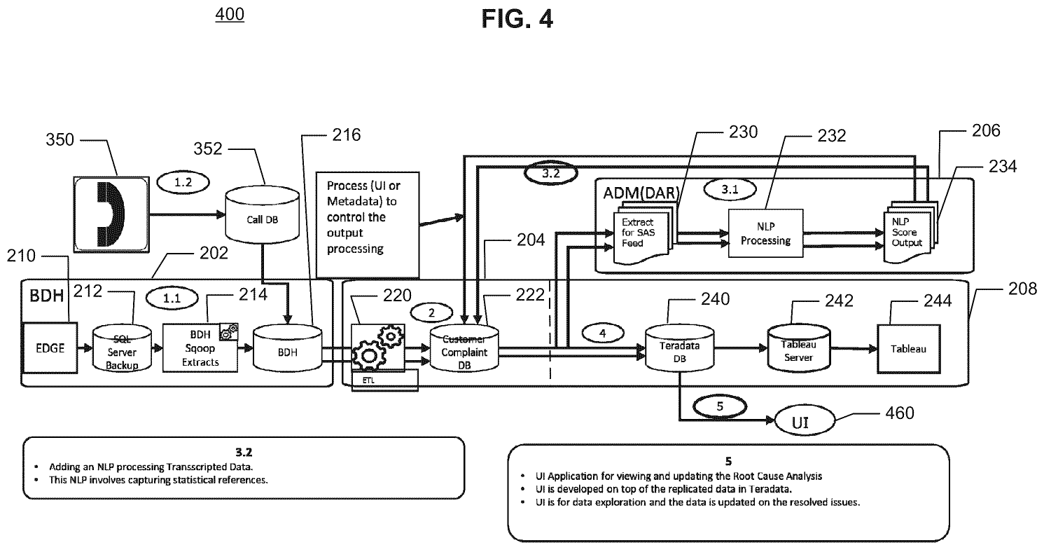

FIG. 4 is a diagram of a third exemplary system 400 for performing customer complaint analytics. Elements of system 400 that are the same as elements of system 200 or system 300 have been given the same reference numerals and operate in a similar manner as described above in connection with FIGS. 2 and 3.

The analytics database 240 may be configured to provide output to a user interface application 460. The user interface application 460 may be configured for a user to view and update root cause analysis information relating to a customer complaint. For example, the user may be able to view customer complaint data, resolve the customer complaint, and update the customer complaint record to indicate that the customer complaint was resolved. In some embodiments, the user interface application 360 may present one or more dashboards to the user, with each dashboard containing different information or a subset of information. Each dashboard may be separately navigable and updateable. In some embodiments, a dashboard may be configured for an end-user (e.g., different dashboards may be created for different end-users based on the user's role) and may enable the end-user to provide comments on the complaint or to provide a resolution to the complaint.

In some embodiments, the user interface application 460 may include a machine learning component configured to suggest root cause analysis solutions to resolve the customer complaint. For example, the machine learning model may be used to identify risk within particular customer complaint populations. Such a machine learning model may provide an advantage over typical root cause analysis by using algorithms and historical data to mathematically predict the likelihood that a complaint is relevant to a predetermined topic. For example, if the customer complaint relates to an issue that has been previously resolved, the user interface application 460 may propose the same solution used to resolve the prior complaint to the user when reviewing the customer complaint. In some embodiments, if the issue in the customer complaint has been previously resolved, the solution may be automatically provided to the customer and the customer complaint record may be updated to reflect that the solution was provided and this information is available to the user in the user interface application 460. In some embodiments, if the issue in the customer complaint has been previously resolved, the solution may be automatically provided to the user and the user may confirm whether the proposed solution is acceptable via the user interface application 460. In some embodiments, the user interface application 460 allows the user to update a customer complaint with comments or other information that may be used to resolve the customer complain, help another user to resolve the customer complaint, or included in later reporting and analysis.

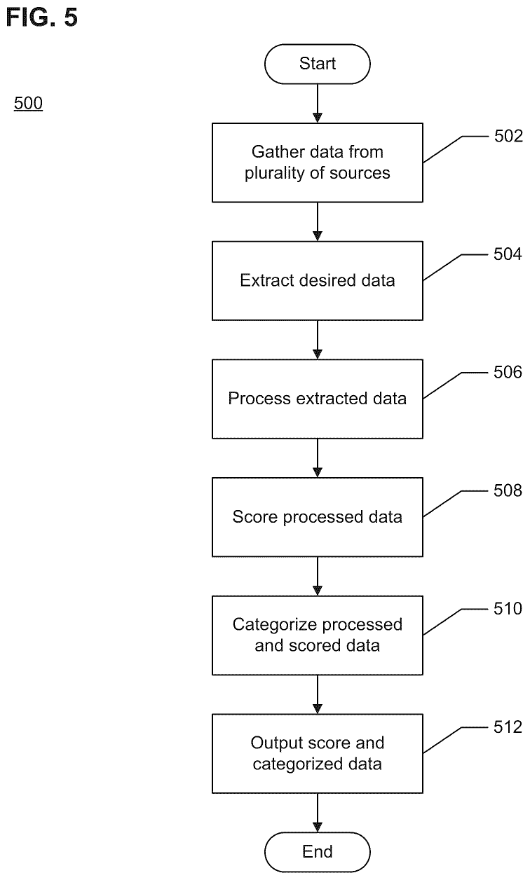

FIG. 5 is a flowchart of a method 500 for performing customer complaint analytics. While the method 500 is explained in the context of performing customer complaint analytics, the scope of the method 500 may be expanded to include different (i.e., non-customer complaint) data sources; the method 500 may operate in the same manner regardless of the types of data being processed.

Data may be gathered from a plurality of sources (step 502). For example, data may be gathered from a data warehouse, a data lake, or other data sources. A data warehouse may include an enterprise-level system for analysis and reporting of data from multiple sources. A data warehouse may store current data and historical data in one location. A data lake may be a centrally located repository for storing, processing, and securing large amounts of data. A data lake may store data in a variety of formats and sizes. The data warehouse and the data lake may both be used in certain systems, as they serve complementary purposes. In the customer complaint example, the data may be stored in one or more databases (e.g., backup storage 210, backup database 212, and relational database 216). This plurality of data sources may include customer information, customer account information, customer complaint information, prior customer complaint information, or customer complaint resolution information.

Desired data may be extracted from the gathered data (step 504). In some embodiments, this step includes performing an extraction, transformation, and loading process. The extraction, transformation, and loading (ETL) process combines data from multiple sources into a single, consistent data store that may be loaded into a target data storage. In the extraction step, data may be copied or exported from one or more source locations to a staging area. In the transformation step, the combined data may be transformed and consolidated for its intended use case. The transformation step may include filtering, cleaning, de-duplicating, validating, authenticating, performing calculations, or formatting the data to match the schema of the target data storage. In the loading step, the transformed data is moved from the staging area to the target data storage.

In the customer complaint example, certain data fields relating to the customer complaint, such as a customer identifier, a customer account identifier, a complaint identifier, a record of prior complaints from the same customer, or prior complaint resolution information may be extracted from the gathered data.

The extracted data may then be processed using natural language processing (step 506). The natural language processing may use any method for text processing, speech processing, morphological analysis, or syntactical analysis, including using neural networks or other machine learning techniques. In the customer complaint example, the natural language processing may be performed by the NLP processing component 232. The NLP processing (e.g., as performed by NLP component 232) may also generate a score for each customer complaint that is analyzed.

The processed data may then be scored as part of the NLP processing based on a plurality of score categories (step 508). In the customer complaint example, the scoring may be performed by the NLP score output component 234. In some embodiments, the scoring may be based on a number of different scoring categories.

The scoring may be performed based on a predetermined number of categories, where the categories are used to separate the customer complaints for later analysis. For example, each customer complaint may be scored in each of the categories and some scores may be zero (i.e., that the complaint does not relate to the particular category) and some scores may be non-zero (i.e., that the complaint has some relevance to the category, with a higher score indicating a higher relevance to the category). In some embodiments, all the scores for a customer complaint may be stored, including the categories which receive a zero score. As an example, the scores may be stored as a one-dimensional vector including the zero elements. As another example, the scores may be stored for each category as a “yes/no” value to indicate whether the customer complaint is relevant to the particular category or not. In some embodiments, only the non-zero scores may be stored and include an identifier of each category. As an example, the scores may be stored as a two-dimensional vector including a category identifier and the associated score.

The processed data may be placed into categories based on the score and the score category (step 510). In the customer complaint example, the categorizing may be performed by the NLP score output component 234 or when the scored data is stored in the customer complaint database 222.

The score and the categorized data may then be output for reporting and analysis (step 512). In the customer complaint example, the scored and categorized data may be transferred from the customer complaint database 222 to the reporting and analysis section 208 (e.g., analytics database 240, reporting database 242, and reporting component 244). In some embodiments, the scored and categorized data may be transferred from the customer complaint database 222 to the user interface application 460 for display and analysis.

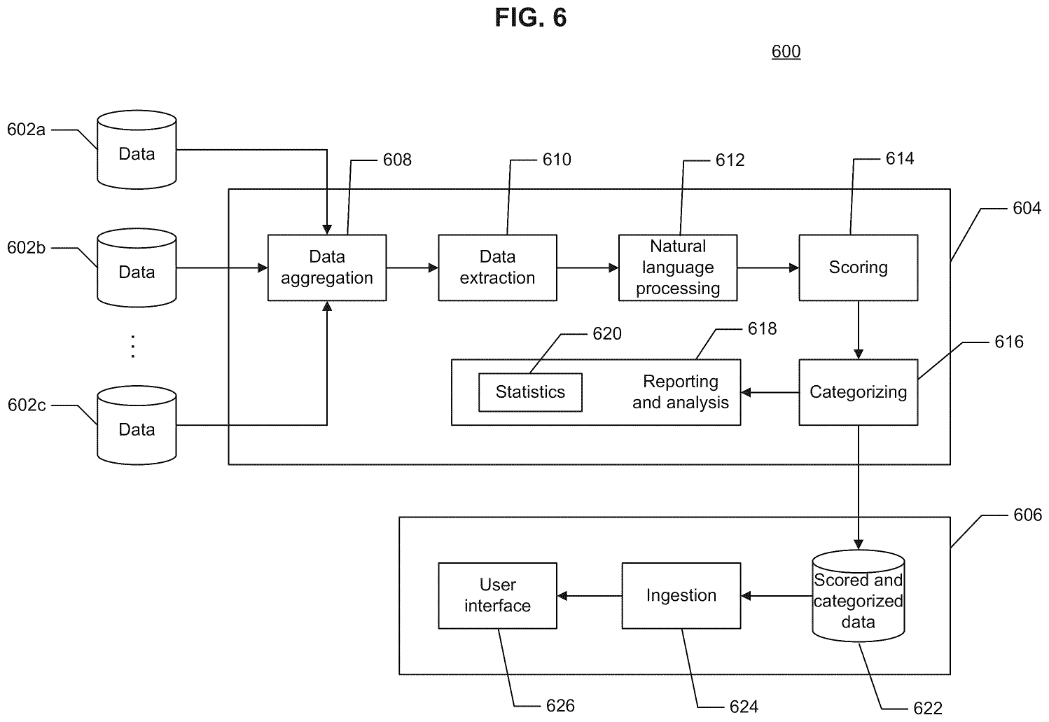

FIG. 6 is a diagram of a fourth exemplary system 600 for performing customer complaint analytics. System 600 includes a plurality of data sources 602a, 602b, 602c; a reporting and analysis application 604; and a root cause analysis application 606. In some embodiments, the root cause analysis application 606 is optional and may not be included in the system 600.

The plurality of data sources 602a-602c may include any one or more of a data warehouse, a data lake, or other data sources. In some embodiments, the data may be stored in one or more databases (e.g., backup storage 210, backup database 212, and relational database 216). The plurality of data sources 602a-602c may store information such as customer information, customer account information, customer complaint information, prior customer complaint information, or customer complaint resolution information. In some embodiments, the plurality of data sources 602a-602c may include a component (not shown in FIG. 6) configured to observe one or more social media platforms to identify public complaints. The public complaint may be a new customer complaint or may relate to an existing customer complaint.

The reporting and analysis application 604 includes a data aggregation component 608, a data extraction component 610, a natural language processing component 612, a scoring component 614, a categorizing component 616, and a reporting and analysis component 618. The reporting and analysis component 618 includes a statistics component 620.

The data aggregation component 608 gathers data from the plurality of data sources 602a-602c. In some embodiments, the data aggregation component 608 may include a database or may store the collected data in a database or data storage separate from the data sources 602a-602c.

The data extraction component 610 extracts desired data from the gathered data. For example, certain data fields relating to the customer complaint, such as a customer identifier, a customer account identifier, a complaint identifier, a record of prior complaints from the same customer, or prior complaint resolution information may be extracted from the gathered data. In some embodiments, the data extraction component 610 may include a database or may store the extracted data in a database or data storage separate from the data sources 602a-602c.

The natural language processing component 612 processes the extracted data. The natural language processing component 612 may use any method for text processing, speech processing, morphological analysis, or syntactical analysis, including using neural networks or other machine learning techniques.

The scoring component 614 scores the processed data based on a plurality of score categories. The categorizing component 616 categorizes the processed data into a plurality of categories based on the score and the score category.

The reporting and analysis component 618 outputs the score and the categorized data for reporting and analysis. In some embodiments, the reporting and analysis component 618 is configured to perform the reporting and analysis of the scored and categorized data and may output the reporting and analysis results. The statistics component 620 may perform additional statistical analysis on the scored and categorized data and may output the results.

The root cause analysis application 606 includes stored scored and categorized data 622, an ingestion component 624, and a user interface component 626. The stored scored and categorized data 622 may be received directly from the categorizing component 616 and may be stored in parallel while the reporting and analysis component 618 is operating. The ingestion component 624 processes the stored scored and categorized data 622 for display in the user interface component 626. The user interface component 626 permits a user to view and update root cause analysis information relating to a customer complaint. For example, the user may be able to view customer complaint data, resolve the customer complaint, and update the customer complaint record to indicate that the customer complaint was resolved. In some embodiments, the user interface component 626 may include a machine learning component configured to suggest root cause analysis solutions to resolve the customer complaint. For example, if the customer complaint relates to an issue that has been previously resolved, the user interface component 626 may propose the same solution used to resolve the prior complaint to the user when reviewing the customer complaint. In some embodiments, if the issue in the customer complaint has been previously resolved, the solution may be automatically provided to the customer and the customer complaint record may be updated to reflect that the solution was provided and this information is available to the user in the user interface component 626. In some embodiments, if the issue in the customer complaint has been previously resolved, the solution may be automatically provided to the user and the user may confirm whether the proposed solution is acceptable via the user interface component 626. In some embodiments, the user interface component 626 allows the user to update a customer complaint with comments or other information that may be used to resolve the customer complain, help another user to resolve the customer complaint, or included in later reporting and analysis.

The present disclosure has been presented for purposes of illustration. It is not exhaustive and is not limited to precise forms or embodiments disclosed. Modifications and adaptations of the embodiments will be apparent from consideration of the specification and practice of the disclosed embodiments. For example, the described implementations include hardware, but systems and methods consistent with the present disclosure can be implemented with hardware and software. In addition, while certain components have been described as being coupled to one another, such components may be integrated with one another or distributed in any suitable fashion.

Moreover, while illustrative embodiments have been described herein, the scope includes any and all embodiments having equivalent elements, modifications, omissions, combinations (e.g., of aspects across various embodiments), adaptations and/or alterations based on the present disclosure. The elements in the claims are to be interpreted broadly based on the language employed in the claims and not limited to examples described in the present specification or during the prosecution of the application, which examples are to be construed as nonexclusive. Further, the steps of the disclosed methods can be modified in any manner, including reordering steps and/or inserting or deleting steps.

The features and advantages of the disclosure are apparent from the detailed specification, and thus, it is intended that the appended claims cover all systems and methods falling within the true spirit and scope of the disclosure. As used herein, the indefinite articles “a” and “an” mean “one or more.” Similarly, the use of a plural term does not necessarily denote a plurality unless it is unambiguous in the given context. Words such as “and” or “or” mean “and/or” unless specifically directed otherwise. Further, since numerous modifications and variations will readily occur from studying the present disclosure, it is not desired to limit the disclosure to the exact construction and operation illustrated and described, and accordingly, all suitable modifications and equivalents may be resorted to, falling within the scope of the disclosure.

Other embodiments will be apparent from consideration of the specification and practice of the embodiments disclosed herein. It is intended that the specification and examples be considered as example only, with a true scope and spirit of the disclosed embodiments being indicated by the following claims.

According to some embodiments, the operations, techniques, and/or components described herein can be implemented by a device or system, which can include one or more special-purpose computing devices. The special-purpose computing devices can be hard-wired to perform the operations, techniques, and/or components described herein, or can include digital electronic devices such as one or more application-specific integrated circuits (ASICs) or field programmable gate arrays (FPGAs) that are persistently programmed to perform the operations, techniques and/or components described herein, or can include one or more hardware processors programmed to perform such features of the present disclosure pursuant to program instructions in firmware, memory, other storage, or a combination. Such special-purpose computing devices can also combine custom hard-wired logic, ASICs, or FPGAs with custom programming to accomplish the technique and other features of the present disclosure. The special-purpose computing devices can be desktop computer systems, portable computer systems, handheld devices, networking devices, or any other device that can incorporate hard-wired and/or program logic to implement the techniques and other features of the present disclosure.

The one or more special-purpose computing devices can be generally controlled and coordinated by operating system software, such as IOS, Android, Blackberry, Chrome OS, Windows XP, Windows Vista, Windows 7, Windows 8, Windows Server, Windows CE, Unix, Linux, SunOS, Solaris, VxWorks, or other compatible operating systems. In other embodiments, the computing device can be controlled by a proprietary operating system. Operating systems can control and schedule computer processes for execution, perform memory management, provide file system, networking, I/O services, and provide a user interface functionality, such as a graphical user interface (“GUI”), among other things.

Furthermore, although aspects of the disclosed embodiments are described as being associated with data stored in memory and other tangible computer-readable storage mediums, one skilled in the art will appreciate that these aspects can also be stored on and executed from many types of tangible computer-readable media, such as secondary storage devices, like hard disks, floppy disks, or CD-ROM, or other forms of RAM or ROM. Accordingly, the disclosed embodiments are not limited to the above described examples, but instead are defined by the appended claims in light of their full scope of equivalents.

Moreover, while illustrative embodiments have been described herein, the scope includes any and all embodiments having equivalent elements, modifications, omissions, combinations (e.g., of aspects across various embodiments), adaptations or alterations based on the present disclosure. The elements in the claims are to be interpreted broadly based on the language employed in the claims and not limited to examples described in the present specification or during the prosecution of the application, which examples are to be construed as non-exclusive. Further, the steps of the disclosed methods can be modified in any manner, including by reordering steps or inserting or deleting steps.

It is intended, therefore, that the specification and examples be considered as example only, with a true scope and spirit being indicated by the following claims and their full scope of equivalents.

1.-20. (canceled)

21. A system comprising:
a data extraction component configured to extract a subset of data from a plurality of data sources, the data including one or more keywords and the plurality of data sources including at least one chosen from the set of:
audio data, and
text data;
a scoring component configured to generate a score for the extracted data based on the one or more keywords using one method chosen from the set of:
text processing,
speech processing,
morphological analysis, and
syntactical analysis;
a storage component configured to store the score in a vector;
a statistics component configured to generate statistics based on the extracted data; and
a score output component configured to:
normalize the score based on the statistics and based on the vector, and
store the score in a database to be associated with the extracted data.

22. The system of claim 21, wherein the scoring component is further configured to categorize the extracted data into a predetermined number of categories.

23. The system of claim 22, wherein the predetermined number of categories are used to separate one or more customer complaints for later analysis.

24. The system of claim 23, wherein the scoring component generates the score for the one or more customer complaints based on a degree of relationship of the one or more customer complaints to each of the predetermined number of categories.

25. The system of claim 24, wherein the vector is a one-dimensional vector that includes the score for the one or more customer complaints.

26. The system of claim 24, wherein the vector is a two-dimensional vector that includes a category identifier and the score associated with the category identifier.

27. The system of claim 24, wherein the database is a customer complaint database, and the score is stored in association with one of the one or more customer complaints.

28. The system of claim 22, wherein the score is further based on one or more category rules that can be redefined to identify one or more new data trends.

29. The system of claim 28, wherein the scoring component is further configured to rescore, in response to at least one of the one or more category rules being redefined, the extracted data to generate a second score.

30. The system of claim 21, wherein the scoring component is further configured to rescore, in response to a trigger, the extracted data to generate a second score.

31. A non-transitory computer-readable medium storing a set of instructions that, when executed by one or more processors of a computing system, cause the computing system to:
extract, using a data extraction component, a subset of data from a plurality of data sources, the data including one or more keywords and the plurality of data sources including at least one chosen from the set of:
audio data, and
text data;
generate, using a scoring component, a score for the extracted data based on the one or more keywords using one method chosen from the set of:
text processing,
speech processing,
morphological analysis, and
syntactical analysis;
store, using a storage component, the score in a vector;
generate, using a statistics component, statistics based on the extracted data; and
normalize the score based on the statistics and based on the vector using a score output component; and
store, using the score output component, the score in a database to be associated with the extracted data.

32. The non-transitory computer-readable medium of claim 31, wherein the scoring component is further configured to categorize the extracted data into a predetermined number of categories.

33. The non-transitory computer-readable medium of claim 32, wherein the predetermined number of categories are used to separate one or more customer complaints for later analysis.

34. The non-transitory computer-readable medium of claim 33, wherein the scoring component generates the score for the one or more customer complaints based on a degree of relationship of the one or more customer complaints to each of the predetermined number of categories.

35. The non-transitory computer-readable medium of claim 34, wherein the vector is a one-dimensional vector that includes the score for the one or more customer complaints.

36. The non-transitory computer-readable medium of claim 34, wherein the vector is a two-dimensional vector that includes a category identifier and the score associated with the category identifier.

37. The non-transitory computer-readable medium of claim 34, wherein the database is a customer complaint database, and the score is stored in association with one of the one or more customer complaints.

38. The non-transitory computer-readable medium of claim 32, wherein the score is further based on one or more category rules that can be redefined to identify one or more new data trends.

39. The non-transitory computer-readable medium of claim 38, wherein the scoring component is further configured to rescore, in response to at least one of the one or more category rules being redefined, the extracted data to generate a second score.

40. The non-transitory computer-readable medium of claim 31, wherein the scoring component is further configured to rescore, in response to a trigger, the extracted data to generate a second score.
